(19) United States
(12) Patent Application Publication
(10) Pub. No.: US 2023/0202238 A1
(43) Pub. Date: Jun. 29, 2023

(54) PNEUMATIC TIRE

(71) Applicant: Toyo Tire Corporation, Itami-shi (JP)

(72) Inventor: Masaru Tada, Itami-shi (JP)

(73) Assignee: Toyo Tire Corporation, Itami-shi (JP)

(21) Appl. No.: 18/078,243

(22) Filed: Dec. 9, 2022

(30) Foreign Application Priority Data
Dec. 24, 2021 (JP) 2021-211491

(51) Int. Cl. B60C 11/03; B60C 11/12

(52) U.S. Cl. CPC B60C 11/0304; B60C 11/0302; B60C 11/0306; B60C 11/1204; B60C 11/1236

(57) ABSTRACT

A pneumatic tire includes a main groove, a first block line provided on one side in a width direction of the main groove, and a second block line provided on the other side in the width direction of the main groove. A first block included in the first block line has a first acute angle portion sectioned at an acute angle by the main groove and a first lateral groove, and a first reinforcing protrusion protruding from the first acute angle portion side of a side wall facing the main groove to the main groove. A second block included in the second block line has a second acute angle portion sectioned at an acute angle by the main groove and a second lateral groove, and a second reinforcing protrusion protruding from the second acute angle portion side of a side wall facing the main groove to the main groove.

### BACKGROUND OF THE INVENTION

### 1. Field of the Invention

The present invention relates to a pneumatic tire.

### 2. Description of Related Art

There exists a pneumatic tire provided with blocks formed by a main groove extending in a tire circumferential direction and lateral grooves extending in a tire width direction on a tread. In the tire provided with such blocks, rigidity at corner portions of the blocks tends to be reduced, which may reduce steering stability.

JP2020-40656A discloses that protrusions protruding to a main groove are provided on side walls of blocks facing the main groove to thereby reinforce the blocks in order to increase the rigidity of the blocks and improve steering stability.

When such protrusions are provided over a wide range or the protrusions are made to protrude largely from side walls of the blocks, the rigidity of the blocks can be improved on a large scale; however, drainability may be impaired due to reduction in groove volume of the main groove.

### SUMMARY OF THE INVENTION

An object of the present invention is to provide a pneumatic tire capable of securing drainability of the main groove while improving the rigidity of blocks and improving steering stability.

According to an aspect of the invention, there is provided a pneumatic tire that includes a main groove extending in a tire circumferential direction, a first block line provided on one side in a width direction of the main groove, and a second block line provided on the other side in the width direction of the main groove on a tread, in which the first block line includes a plurality of first blocks formed by being divided in the tire circumferential direction by first lateral grooves extending while being inclined with respect to a tire width direction, the second block line includes a plurality of second blocks formed by being divided in the tire circumferential direction by second lateral grooves extending while being inclined with respect to the tire width direction, the first block has a first obtuse angle portion sectioned at an obtuse angle by the main groove and the first lateral groove, a first acute angle portion sectioned at an acute angle by the main groove and the first lateral groove, and a first reinforcing protrusion provided from the first acute angle portion side of a side wall facing the main groove toward a groove bottom of the main groove and protruding to the main groove, the second block has a second obtuse angle portion sectioned at an obtuse angle by the main groove and the second lateral groove, a second acute angle portion sectioned at an acute angle by the main groove and the second lateral groove, and a second reinforcing protrusion provided from the second acute angle portion side of a side wall facing the main groove toward a groove bottom of the main groove and protruding to the main groove, and the first reinforcing protrusions and the second reinforcing protrusions are alternately arranged in the tire circumferential direction.

Since the present invention has the above characteristics, it is possible to secure the groove volume of the main groove while improving rigidity of the blocks and improving steering stability.

### BRIEF DESCRIPTION OF THE DRAWINGS

FIG. 1 is a development view showing a tread pattern of a pneumatic tire according to an embodiment;

FIG. 2 is a main-part enlarged plan view of the tread pattern in FIG. 1;

FIG. 3 is a cross-sectional view taken along III-III line in FIG. 2; and

FIG. 4 is a main-part enlarged perspective view showing the pneumatic tire according to the embodiment.

### DESCRIPTION OF EMBODIMENTS

Hereinafter, an embodiment of the present invention will be explained with reference to the drawings.

A tire according to the embodiment is a pneumatic tire, which is provided with right and left pair of bead parts and sidewalls, and a tread provided between both sidewalls so as to connect outer end portions in a radial direction of the right and left sidewalls to each other. An internal configuration of the tire is not particularly limited, and the tire is formed by including, for example, annular bead cores embedded in beads, a radial-structured carcass ply extending in a toroidal shape between the pair of beads, a belt, a tread rubber, and the like provided on an outer side in the tire radial direction of the carcass ply on the tread. In the embodiment, a general tire structure can be adopted except for a tread pattern.

Respective shapes and dimensions in this description are measured in a normal state with no load in which the tire is fitted to a normal rim and a normal internal pressure is filled unless otherwise noted. The normal rim corresponds to the “standard rim” in the JATMA standard, “Design Rim” in the TRA standard, or “Measuring Rim” in the ETRTO standard. The normal internal pressure corresponds to the “maximum air pressure” in the JATMA standard, the “maximum value” described in “TIRE LOAD LIMITS AT VARIOUS COLD INFLATION PRESSURES” in the TRA standard, or “INFLATION PRESSURE” in the ETRTO standard.

### Basic Structure of Tread 10

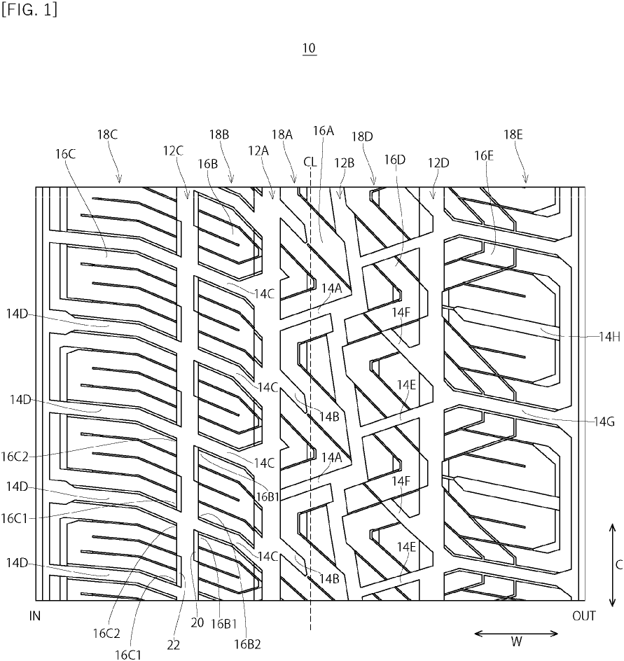

FIG. 1 is a partial development view of a tread 10 of the tire according to the embodiment. In the drawing, a symbol CL denotes a tire equatorial plane corresponding to the center in the tire width direction. A symbol W denotes the tire width direction (also referred to as a tire axial direction). An inside in the tire width direction W indicates the side closer to the tire equatorial plane CL. An outside in the tire width direction W indicates the side farther from the tire equatorial plane CL. A symbol C denotes a tire circumferential direction which is a direction on a circumference centered at a tire rotation axis.

The tire shown in FIG. 1 is a tire in which front and back sides are designated when mounted to a vehicle. That is, a surface facing the outside and a surface facing the inside when mounted to the vehicle are designated. Accordingly, an indication for designating a mounting direction to the vehicle is provided on, for example, a sidewall surface of the tire. The tire is mounted to the vehicle so that a side denoted by a symbol OUT faces the outside (vehicle outside) in a vehicle mounted posture and a side denoted by a symbol IN faces the inside (vehicle inside) in the vehicle mounted posture in FIG. 1.

As shown in FIG. 1, four main grooves 12A, 12B, 12C, and 12D extending in a tire circumferential direction C, lateral grooves 14A, 14B, 14C, 14D, 14E, 14F, 14G, and 14H extending in the tire width direction W, and blocks 16A, 16B, 16C, 16D, and 16E are provided on the surface of the tread 10.

Specifically, a pair of center main grooves 12A, 12B and a pair of shoulder main grooves 12C, 12D are provided on the tread 10. The pair of center main grooves 12A, 12B are arranged on both sides of the tire equatorial plane CL. The pair of shoulder grooves 12C, 12D are respectively arranged on outer sides in the tire width direction of the center main grooves 12A, 12B.

In the embodiment, the inside center main groove 12A in the vehicle inside IN, the inside shoulder main groove 12C in the vehicle inside IN, and the outside shoulder main groove 12D in the vehicle outside OUT extend in the tire circumferential direction C in an approximately straight shape, and the outside center main groove 12B in the vehicle outside OUT extends while bending zigzag in the tire circumferential direction C.

Note that the inside center main groove 12A, the inside shoulder main groove 12C, and the outside shoulder main groove 12D may be zigzag main grooves, and the outside center main groove 12B may be a straight-shaped main groove. That is, the main grooves 12A, 12B, 12C, and 12D do not always have to be parallel to the tire circumferential direction C as long as the grooves extend in the tire circumferential direction C and may be grooves extending in the tire circumferential direction C while being inclined.

A center block line 18A is provided between the inside center main groove 12A and the outside center main groove 12B. The center block line 18A includes a plurality of center blocks 16A formed by being divided in the tire circumferential direction C by first center lateral grooves 14A. The first center lateral groove 14A is a groove extending while being inclined with respect to the tire width direction W and opening to the inside center main groove 12A and the outside center main groove 12B.

The center block 16A is provided with a second center lateral groove 14B which is inclined to the opposite direction of the first center lateral groove 14A. The second center lateral groove 14B is a groove in which one end opens to the inside center main groove 12A and the other side terminates in the center block 16A. The first center lateral grooves 14A and the second center lateral grooves 14B are alternately provided in the tire circumferential direction C. The first center lateral grooves 14A and the second center lateral grooves 14B may be straight-line grooves, curved-line grooves, or grooves each having a bending portion as long as the grooves extend while being inclined with respect to the tire width direction W.

An inside intermediate block line 18B is provided between the inside center main groove 12A and the inside shoulder main groove 12C. The inside intermediate block line 18B includes a plurality of inside intermediate blocks 16B formed by being divided in the tire circumferential direction C by inside intermediate lateral grooves 14C.

The inside intermediate lateral groove 14C is a groove extending while being inclined with respect to the tire width direction W and opening to the inside center main groove 12A and the inside shoulder main groove 12C. A plurality of inside intermediate lateral grooves 14C are provided at intervals in the tire circumferential direction C. The inside intermediate lateral grooves 14C are formed in a straight shape. The inside intermediate lateral grooves 14C may be straight-line grooves, curved-line grooves, or grooves each having a bending portion as long as the grooves extend while being inclined with respect to the tire width direction W.

Since the inside intermediate lateral grooves 14C extend while being inclined with respect to tire width direction W, each of the inside intermediate blocks 16B has an acute angle portion 16B1 and an obtuse angle portion 16B2. The acute angle portion 16B1 is a corner portion formed by the inside intermediate lateral groove 14C crossing the inside shoulder main groove 12C at an acute angle. The obtuse angle portion 16B2 is a corner portion formed by the inside intermediate lateral groove 14C crossing the inside shoulder main groove 12C at an obtuse angle. The acute angle portions 16B1 and the obtuse angle portions 16B2 are alternately provided in the tire circumferential direction C.

An inside shoulder block line 18C is provided on an outer side in the tire width direction of the inside shoulder main groove 12C (namely, between the inside shoulder main groove 12C and a ground contact end). The inside shoulder block line 18C includes a plurality of inside shoulder blocks 16C formed by being divided in the tire circumferential direction C by inside shoulder lateral grooves 14D.

The inside shoulder lateral groove 14D is a groove extending while being inclined with respect to the tire width direction W and opening to the inside shoulder main groove 12C and the ground contact end. An opening of the inside shoulder lateral groove 14D opening to the inside shoulder main groove 12C is formed on an extended line of the inside intermediate lateral groove 14C. The inside shoulder lateral groove 14D is a groove having a bending portion. The inside shoulder lateral grooves 14D may be straight-line grooves, curved-line grooves, or grooves each having a bending portion as long as the grooves extend while being inclined with respect to the tire width direction W.

Since the inside shoulder lateral grooves 14D extend while being inclined with respect to tire width direction W, each of the inside shoulder blocks 16C has an acute angle portion 16C1 and an obtuse angle portion 16C2. The acute angle portion 16C1 is a corner portion formed by the inside shoulder lateral groove 14D crossing the inside shoulder main groove 12C at an acute angle. The obtuse angle portion 16C2 is a corner portion formed by the inside shoulder lateral groove 14D crossing the inside shoulder main groove 12C at an obtuse angle.

The acute angle portions 16C1 and the obtuse angle portions 16C2 of the inside shoulder blocks 16C are alternately provided in the tire circumferential direction C in the same manner as the acute angle portions 16B1 and the obtuse angle portions 16B2 of the inside intermediate blocks 16B. The acute angle portion 16C1 of the inside shoulder block 16C faces the obtuse angle portion 16B2 of the inside intermediate block 16B in a direction in which the inside intermediate lateral groove 14C are extended. The obtuse angle portion 16C2 of the inside shoulder block 16C faces the acute angle portion 16B1 of the inside intermediate block 16B in a direction in which the inside intermediate lateral groove 14C are extended.

An outside intermediate block line 18D is provided between the outside center main groove 12B and the outside shoulder main groove 12D. The outside intermediate block line 18D includes a plurality of outside intermediate blocks 16D formed by being divided in the tire circumferential direction C by first outside intermediate lateral grooves 14E. The first outside intermediate lateral groove 14E is a groove extending while being inclined with respect to the tire width direction W and opening to the outside center main groove 12B and the outside shoulder main groove 12D.

The outside intermediate block 16D is provided with second outside intermediate lateral grooves 14F which is inclined to an opposite direction of the first outside intermediate lateral groove 14E. The second outside intermediate lateral groove 14F is a groove in which one end opens to the outside shoulder main groove 12D and the other end terminates in the outside intermediate block 16D. The first outside intermediate lateral grooves 14E and the second outside intermediate lateral grooves 14F are alternately provided in the tire circumferential direction C. The first outside intermediate lateral grooves 14E and the second outside intermediate lateral grooves 14F may be straight-line grooves, curved-line grooves, or grooves each having a bending portion as long as the grooves extend while being inclined with respect to the tire width direction W. The second outside intermediate lateral groove 14F may be a groove in which one end opens to the outside shoulder main groove 12D and the other end opens to the outside center main groove 12B.

An outside shoulder block line 18E is provided on an outer side in the tire width direction of the outside shoulder main groove 12D (namely, between the outside shoulder main groove 12D and a ground contact end). The outside shoulder block line 18E includes a plurality of outside shoulder blocks 16E formed by being divided in the tire circumferential direction C by the first outside shoulder lateral grooves 14G. The first outside shoulder lateral groove 14G is a groove extending while being inclined with respect to the tire width direction W and opening to the outside shoulder main groove 12D and the ground contact end.

The outside shoulder block 16E is provided with the second outside shoulder lateral groove 14H extending in parallel to the first outside shoulder lateral groove 14G. The second outside shoulder lateral groove 14H is a groove in which one end opens to the ground contact end and the other end terminates in the outside shoulder block 16E. The first outside shoulder lateral grooves 14G and the second outside shoulder lateral grooves 14H are alternately provided in the tire circumferential direction C. The first outside shoulder lateral grooves 14G and the second outside shoulder lateral grooves 14H may be straight-line grooves, curved-line grooves, or grooves each having a bending portion as long as the grooves extend while being inclined with respect to the tire width direction W.

### Inside Intermediate Block 16B and Inside Shoulder Block 16C

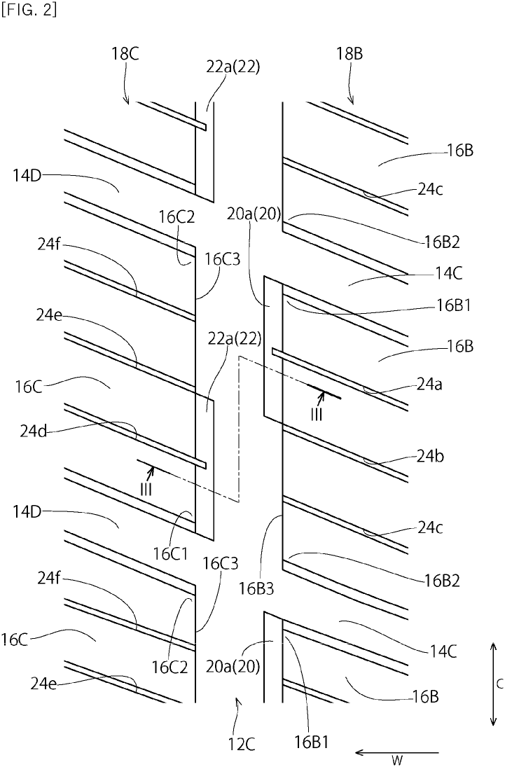

Next, the inside intermediate block 16B and the inside shoulder block 16C will be explained. As shown in FIG. 1 and FIG. 2, the inside intermediate block 16B and the inside shoulder block 16C are respectively provided with reinforcing protrusions 20, 22.

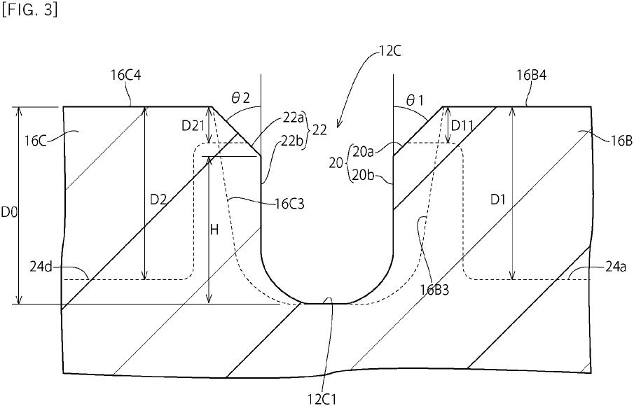

The reinforcing protrusion 20 protrudes from the acute angle portion side in a side wall 16B3 of the inside intermediate block 16B which faces the shoulder main groove 12C toward the center of the shoulder main groove 12C (toward a side wall 16C3 of the inside shoulder block 16C which faces the side wall 16B3). The reinforcing protrusion 20 is provided from a tread surface 16B4 of the inside intermediate block 16B toward a groove bottom 12C1 of the shoulder main groove 12C as shown in FIG. 3.

The reinforcing protrusion 20 includes a tread-surface side inclined surface 20a connected to the tread surface 16B4 of the inside intermediate block 16B and extending toward the groove bottom 12C1 side and a groove-bottom side inclined surface 20b connected to the tread-surface side inclined surface 20a and further extending toward the groove bottom 12C1 side as shown in FIG. 3.

The tread-surface side inclined surface 20a is inclined with respect to the tire radial direction. The groove-bottom side inclined surface 20b is provided approximately in parallel to the tire radial direction. That is, an inclination angle θ1 of the tread-surface side inclined surface 20a with respect to the tire radial direction is larger than an inclination angle of the groove-bottom side inclined surface 20b with respect to the tire radial direction. θ1 is, for example, 25 degrees or more and 65 degrees or less.

Note that the groove-bottom side inclined surface 20b may be inclined with respect to the tire radial direction as long as the inclination angle with respect to the tire radial direction is smaller than the inclination angle θ1 of the tread-surface side inclined surface 20a. The inclination angle of the groove-bottom side inclined surface 20b with respect to the tire radial direction can be 10 degrees or less.

At a place closer to the groove bottom 12C1 than the groove-bottom side inclined surface 20b, a curved surface smoothly connecting the groove-bottom side inclined surface 20b and the groove bottom 12C1 is provided.

The reinforcing protrusion 22 protrudes from the acute angle portion side in a side wall 16C3 of the inside shoulder block 16C which faces the shoulder main groove 12C toward the center of the inside shoulder main groove 12C (toward the side wall 16B3 of the inside intermediate block 16B). The reinforcing protrusion 22 is provided from a tread surface 16C4 of the inside shoulder block 16C toward the groove bottom 12C1 of the shoulder main groove 12C. The above reinforcing protrusions 22 and the reinforcing protrusions 20 provided in the inside intermediate blocks 16B are alternately arranged in the tire circumferential direction C (see FIG. 1 and FIG. 2).

The reinforcing protrusion 22 includes a tread-surface side inclined surface 22a connected to the tread surface 16C4 of the inside shoulder block 16C and extending toward the groove bottom 12C1 side and a groove-bottom side inclined surface 22b connected to the tread-surface side inclined surface 22a and further extending toward the groove bottom 12C1 side.

The tread-surface side inclined surface 22a is inclined with respect to the tire radial direction. The groove-bottom side inclined surface 22b is provided approximately in parallel to the tire radial direction. That is, an inclination angle θ2 of the tread-surface side inclined surface 22a with respect to the tire radial direction is larger than an inclination angle of the groove-bottom side inclined surface 22b with respect to the tire radial direction. θ2 is, for example, 25 degrees or more and 65 degrees or less.

Note that the groove-bottom side inclined surface 22b may be inclined with respect to the tire radial direction as long as the inclination angle with respect to the tire radial direction is smaller than the inclination angle θ2 of the tread-surface side inclined surface 22a. The inclination angle of the groove-bottom side inclined surface 22b with respect to the tire radial direction can be 10 degrees or less.

At a place closer to the groove bottom 12C1 from the groove-bottom side inclined surface 22b, a curved surface smoothly connecting the groove-bottom side inclined surface 22b and the groove bottom 12C1 is provided.

A height H of the groove-bottom side inclined surfaces 20b, 22b of the reinforcing protrusions 20, 22 from the groove bottom 12C1 of the inside shoulder main groove 12C is preferably 50% or more of a depth D0 of the inside shoulder main groove 12C. That is, it is preferable that the tread-surface side inclined surfaces 20a, 22a are provided closer to the tread surface side than a position of 50% of the depth D0 of the inside shoulder main groove 12C. For example, the depth D0 of the inside shoulder main groove 12C may be 5 to 10 cm, the height H of the groove-bottom side inclined surfaces 20b, 22b may be 5 to 8.5 cm, and a height of the tread-surface side inclined surfaces 20a, 22a (length in the tire radial direction) may be 1 to 3 cm.

Additionally, sipes may be provided on the inside intermediate blocks 16B and the inside shoulder blocks 16C. In the embodiment, three sipes 24a, 24b, and 24c are provided on the inside intermediate block 16B, and three sipes 24d, 24e, and 24f are provided on the inside shoulder block 16C.

Here, the sipes are cuts formed on the blocks, which have a minute groove width. The groove width of the sipes is not particularly limited, and may be, for example, 0.1 to 1.5 mm, 0.2 to 1.0 mm or 0.3 to 0.8 mm. The sipes do not always have to be parallel to the tire width direction W as long as the sipes are narrow grooves extending in the tire width direction W and may be narrow grooves extending in the tire width direction W while being inclined. The sipes may be straight-line sipes, curved-line sipes, or sipes each having a bending portion.

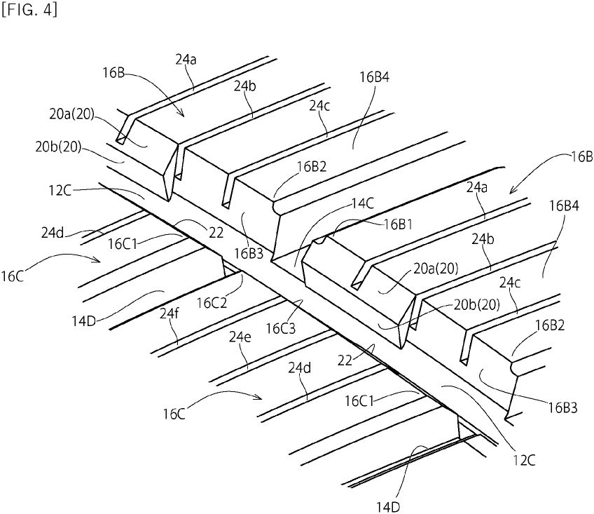

As shown in FIG. 2 and FIG. 4, the three sipes 24a, 24b, and 24c provided on the inside intermediate block 16B extend while being inclined with respect to the tire width direction W and open to the inside shoulder main groove 12C.

Specifically, the sipe 24a is an acute-angle side sipe opening to the reinforcing protrusion 20. As shown in FIG. 3, a depth D1 of the acute-angle side sipe 24a may be the same as, or may be shallower than the depth D0 of the inside shoulder main groove 12C. The depth D1 of the acute-angle side sipe 24a may be constant in an extension direction thereof, or may vary in the extension direction. For example, the acute-angle side sipe 24a may be formed to be shallow at an opening end part to the inside shoulder main groove 12C and may be formed to be deeper at the central part in the extension direction than at the opening end part.

A depth D11 at the opening end part may be shallower than a lower end position of the tread-surface side inclined surface 20a (an upper end position of the groove-bottom side inclined surface 20b), which may be, for example, 10% or more and 90% or less of the depth D0 of the inside shoulder main groove 12C. The acute-angle side sipe 24a may open to the tread-surface side inclined surface 20a, not opening to the groove-bottom side inclined surface 20b.

Moreover, the depth D1 of the acute-angle side sipe 24a at the central part in the extension direction may be deeper than the lower end position of the tread-surface side inclined surface 20a, which may be, for example, 50% or more and 90% or less of the depth D0 of the inside shoulder main groove 12C.

The sipe 24b is a sipe provided at the central part in the tire circumferential direction C of the inside intermediate block 16B, which corresponds to the intermediate sipe 24b opening to a boundary portion between the side wall 16B3 of the inside intermediate block 16B and the reinforcing protrusion 20. In other words, the intermediate sipe 24b is disposed between the acute-angle side sipe 24a and the obtuse-angle side sipe 24c, which opens to a root portion of the reinforcing protrusion 20.

The sipe 24c is the obtuse-angle side sipe 24c opening to the obtuse angle portion side in the side wall 16B3 of the inside intermediate block 16B (namely, a position facing the reinforcing protrusion 22 of the inside shoulder block 16C in the tire width direction W).

The acute-angle side sipe 24a, the intermediate sipe 24b, and the obtuse-angle side sipe 24c are provided in parallel to the inside intermediate lateral groove 14C; however, these sipes can be grooves extending while being inclined with respect to the inside intermediate lateral groove 14C. The acute-angle side sipe 24a and the obtuse-angle side sipe 24c also open to the inside center main groove 12A and are provided so as to completely traverse the inside intermediate block 16B; however, these sipes do not always have to completely traverse the block. Moreover, the intermediate sipe 24b do not have to completely traverse the inside intermediate block 16B as in the shown example, but can completely traverse the block.

As shown in FIG. 2, the three sipes 24d, 24e, and 24f provided on the inside shoulder block 16C extend while being inclined with respect to the tire width direction W and open to the inside shoulder main groove 12C.

Specifically, the sipe 24d is an acute-angle side sipe opening to the reinforcing protrusion 22. The acute-angle side sipe 24d may be provided on an extension of the obtuse-angle side sipe 24c provided in the inside intermediate block 16B as shown in FIG. 2.

A depth D2 of the acute-angle side sipe 24d may be the same as, or may be shallower than the depth D0 of the inside shoulder main groove 12C in the same matter as the acute-angle side sipe 24a provided in the inside intermediate block 16B. The depth D2 of the acute-angle side sipe 24d may be constant in an extension direction thereof, or may vary in the extension direction. For example, the acute-angle side sipe 24a may be formed to be shallow at an opening end part to the inside shoulder main groove 12C and may be formed to be deeper at the central part in the extension direction than at the opening end part.

The depth D21 at the opening end part may be shallower than a lower end position of the tread-surface side inclined surface 22a (an upper end position of the groove-bottom side inclined surface 22b), which may be, for example, 10% or more and 90% or less of the depth D0 of the inside shoulder main groove 12C. The acute-angle side sipe 24d may open to the tread-surface side inclined surface 22a, not opening to the groove-bottom side inclined surface 22b.

Moreover, the depth D2 of the acute-angle side sipe 24d at the central part in the extension direction may be deeper than the lower end position of the tread-surface side inclined surface 22a, which may be, for example, 50% or more and 90% or less of the depth D0 of the inside shoulder main groove 12C.

The sipe 24e is a sipe provided at the central part in the tire circumferential direction C of the inside shoulder block 16C, which corresponds to the intermediate sipe 24e opening to a boundary portion between the side wall 16C3 of the inside shoulder block 16C and the reinforcing protrusion 22. In other words, the intermediate sipe 24e is disposed between the acute-angle side sipe 24d and the obtuse-angle side sipe 24f, which opens to a root portion of the reinforcing protrusion 22. The intermediate sipe 24e may be provided on an extension of the intermediate sipe 24b provided in the inside intermediate block 16B as shown in FIG. 2.

The sipe 24f is the obtuse-angle side sipe 24f opening to the obtuse angle portion side in the side wall 16C3 of the inside shoulder block 16C (namely, a position facing the reinforcing protrusion 20 of the inside intermediate block 16B in the tire width direction W). The obtuse-angle side sipe 24f may be provided on an extension of the acute-angle side sipe 24a provided in the inside intermediate block 16B as shown in FIG. 2.

The acute-angle side sipe 24d, the intermediate sipe 24e, and the obtuse-angle side sipe 24f are provided in parallel to the inside shoulder lateral groove 14D; however, these sipes can be grooves extending while being inclined with respect to the inside shoulder lateral groove 14D.

### Advantageous Effects

In the above-described pneumatic tire according to the embodiment, the reinforcing protrusion 20 is provided on the side wall 16B3 on the acute angle portion 16B1 side of the inside intermediate block 16B, and the reinforcing protrusion 22 is provided on the side wall 16C3 on the acute angle portion 16C1 side of the inside shoulder block 16C; therefore, rigidity difference between the acute angle portions 16B1, 16C1 and the obtuse angle portions 16B2, 16C2 can be reduced while improving block rigidity of the inside intermediate block 16B and the inside shoulder block 16C, which can improve steering stability and can suppress uneven wear.

Moreover, the reinforcing protrusions 20 provided in the inside intermediate blocks 16B and the reinforcing protrusions 22 provided in the inside shoulder blocks 16C are alternately arranged in the inside shoulder main groove 12C in the tire circumferential direction C. Accordingly, a cross-sectional area of the groove is not locally narrowed due to the reinforcing protrusions 20, 22; therefore, drainability can be secured even when the reinforcing protrusions 20, 22 protruding to the inside shoulder main groove 12C are provided.

Since the reinforcing protrusions 20, 22 do not face each other in the tire width direction W in the embodiment, a distance between the inside intermediate block 16B and the inside shoulder block 16C can be secured on the groove bottom side of the inside shoulder main groove 12C, and generation of cracks can be suppressed on the groove bottom 12C1.

The flow velocity of air passing in the inside shoulder main groove 12C while traveling can be slowed down due to the reinforcing protrusions 20, 22 in the embodiment; therefore, noise caused by air column resonance can be suppressed.

In the embodiment, since the reinforcing protrusions 20, 22 have the tread-surface side inclined surfaces 20a, 22a described above, the inside intermediate blocks 16B and the inside shoulder blocks 16C are deformed at the time of cornering and the tread-surface side inclined surfaces 20a, 22a contact the ground to thereby secure the ground contact area, which can improve steering stability.

Since the acute-angle side sipes 24a, 24d opening to the reinforcing protrusions 20, 22 are provided in the embodiment, snow column shearing force for snow columns formed in the inside shoulder main groove 12C at the time of traveling on an icy and snowy road is increased to thereby improve traction performance.

In addition, the snow columns formed in the inside shoulder main groove 12C at the time of traveling on the icy and snowy road surface are captured by the reinforcing protrusions 20, 22 in the embodiment. In that case, the intermediate sipes 24b, 24e are provided at the boundary portion between the side wall 16B3 of the inside intermediate block 16B and the reinforcing protrusion 20, and the boundary portion between the side wall 16C3 of the inside shoulder block 16C and the reinforcing protrusion 22; therefore, the intermediate sipes 24b, 24e open to thereby soften the blocks 16B, 16C and the snow columns can be effectively used, as a result, performance at the time of braking and acceleration on the icy and snowy road surface can be improved.

The present invention is not at all limited by the above embodiment, and various modifications and alterations may be made within a scope not departing from the gist of the invention.

### Reference Signs List

10: tread
12A: inside center main groove
12B: outside center main groove
12C: inside shoulder main groove
12C1: groove bottom
12D: outside shoulder main groove
14A: first center lateral groove
14B: second center lateral groove
14C: inside intermediate lateral groove
14D: inside shoulder lateral groove
14E: first outside intermediate lateral groove
14F: second outside intermediate lateral groove
14G: first outside shoulder lateral groove
14H: second outside shoulder lateral groove
16A: center block
16B: inside intermediate block
16B1: acute angle portion
16B2: obtuse angle portion
16B3: side wall
16B4: tread surface
16C: inside shoulder block
16C1: acute angle portion
16C2: obtuse angle portion
16C3: side wall
16D: outside intermediate block
16E: outside shoulder block
18A: center block line
18B: inside intermediate block line
18C: inside shoulder block line
18D: outside intermediate block line
18E: outside shoulder block line
20: reinforcing protrusion
20a: tread-surface side inclined surface
20b: groove-bottom side inclined surface
22: reinforcing protrusion
22a: tread-surface side inclined surface
22b: groove-bottom side inclined surface
24a: acute-angle side sipe
24b: intermediate sipe
24c: obtuse-angle side sipe
24d: acute-angle side sipe
24e: intermediate sipe
24f: obtuse-angle side sipe

What is claimed is:

1. A pneumatic tire comprising:
a main groove extending in a tire circumferential direction;
a first block line provided on one side in a width direction of the main groove; and
a second block line provided on the other side in the width direction of the main groove on a tread,
wherein the first block line includes a plurality of first blocks formed by being divided in the tire circumferential direction by first lateral grooves extending while being inclined with respect to a tire width direction,
the second block line includes a plurality of second blocks formed by being divided in the tire circumferential direction by second lateral grooves extending while being inclined with respect to the tire width direction,
the first block has a first obtuse angle portion sectioned at an obtuse angle by the main groove and the first lateral groove, a first acute angle portion sectioned at an acute angle by the main groove and the first lateral groove, and a first reinforcing protrusion provided from the first acute angle portion side of a side wall facing the main groove toward a groove bottom of the main groove and protruding to the main groove,
the second block has a second obtuse angle portion sectioned at an obtuse angle by the main groove and the second lateral groove, a second acute angle portion sectioned at an acute angle by the main groove and the second lateral groove, and a second reinforcing protrusion provided from the second acute angle portion side of a side wall facing the main groove toward a groove bottom of the main groove and protruding to the main groove, and
the first reinforcing protrusions and the second reinforcing protrusions are alternately arranged in the tire circumferential direction.

2. The pneumatic tire according to claim 1,
wherein the first block includes a first acute-angle side sipe opening to the first reinforcing protrusion, and
the second block includes a second acute-angle side sipe opening to the second reinforcing protrusion.

3. The pneumatic tire according to claim 1,
wherein the first block includes a first intermediate sipe opening to a boundary portion between the side wall facing the main groove and the first reinforcing protrusion, and
the second block includes a second intermediate sipe opening to a boundary portion between the side wall facing the main groove and the second reinforcing protrusion.

4. The pneumatic tire according to claim 1,
wherein the main groove is a shoulder main groove provided at a position closest to a ground contact end.

5. The pneumatic tire according to claim 1,
wherein the first reinforcing protrusion includes a first tread-surface side inclined surface connected to a tread surface of the first block, in which a protrusion height from the groove bottom is reduced toward a distal end side in a protruding direction of the first reinforcing protrusion, and a first groove-bottom side inclined surface connected to a groove-bottom side of the first tread-surface side inclined surface and inclined so that an angle with respect to a tire radial direction is smaller than that of the first tread-surface side inclined surface,
the second reinforcing protrusion includes a second tread-surface side inclined surface connected to a tread surface of the second block, in which a protrusion height from the groove bottom is reduced toward a distal end side in a protruding direction of the second reinforcing protrusion, and a second groove-bottom side inclined surface connected to a groove-bottom side of the second tread-surface side inclined surface and inclined so that an angle with respect to the tire radial direction is smaller than that of the second tread-surface side inclined surface, and
the first tread-surface side inclined surface and the second tread-surface side inclined surface are provided closer to the tread surface side than a position of 50% of a groove depth of the main groove.
